(19) United States
(12) Patent Application Publication
(10) Pub. No.: US 2013/0004071 A1
(43) Pub. Date: Jan. 3, 2013

(54) IMAGE SIGNAL PROCESSOR ARCHITECTURE OPTIMIZED FOR LOW-POWER, PROCESSING FLEXIBILITY, AND USER EXPERIENCE

(76) Inventors: YUH-LIN E. CHANG, Fremont, CA (US); Ravi Kolagotla, Austin, CA (US); Madhu S. Athreya, Saratoga, CA (US)

(21) Appl. No.: 13/175,741

(22) Filed: Jul. 1, 2011

(51) Int. Cl. G06K 9/00

(52) U.S. Cl. 382/167

(57) ABSTRACT

Methods and apparatus relating to an image signal processor architecture that may be optimized for low-power consumption, processing flexibility, and/or user experience are described. In an embodiment, an image signal processor may be partitioned into a plurality of partitions. Each partition may be capable of entering a lower power consumption state. Also, processing by each partition may be done in various modes to optimize for low-power consumption, processing flexibility, and/or user experience. Other embodiments are also disclosed and claimed.

### FIELD

The present disclosure generally relates to the field of electronics. More particularly, some embodiments of the invention relates to image signal processor architecture that is optimized for low-power, processing flexibility, and/or user experience.

### BACKGROUND

As mobile computing devices become more common place, it is imperative to reduce power consumption in such devices as much as possible while maintaining usability. More particularly, since mobile computing devices generally rely on batteries with limited life, the amount of power consumed for various operations needs to be closely guarded.

Further, as an increasing number of mobile computing devices (such as Smartphones) tend to include digital cameras, users may use these devices for digital image processing operations. Digital image processing is generally computation intensive, in part, since digital images include a relatively large amount of data. Accordingly, it is important to perform image processing operations in such devices more efficiently to reduce power consumption. Moreover, power consumption considerations are not limited to mobile computing devices, e.g., due to environmental concerns associated with generating additional power, heat generation resulting from increased power consumption, etc.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-5 illustrate block diagrams of various computing devices used for image signal processing, in accordance with some embodiments.

FIGS. 6-7 illustrate block diagrams of computing systems, according to some embodiments.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

Some embodiments may partition an Image Signal Processor (ISP) pipeline architecture in order to optimize power consumption, user experience, and/or content adjustable processing. For example, the ISP system architecture may be partitioned into a plurality of stages/partitions and the ISP data flow may be designed in order to improve efficiency and/or flexibility. To this end, a full ISP pipeline may be divided into multiple stages in order to create different modes of processing. Each mode may be in turn optimized for different conditions such as power, efficiency, memory bandwidth, latency, etc. In an embodiment, a statistics gathering module may be provided at the end of a stage (e.g., before writing data to memory) in order to enable content-based processing for the next stage. In an embodiment, local and/or global statistics may be gathered where local statistics relate to image characteristics based on a local neighborhood in the image and global statistics relate to image characteristics based on the whole image.

Moreover, the techniques discussed herein may be applied to any type of a ISP device, including for example mobile devices (such as a mobile phone, a laptop computer, a personal digital assistant (PDA), an ultra-portable personal computer, tablet, etc.) or non-mobile computing devices (such as a desktop computer, a server, etc.).

Furthermore, wireless or wired communication channels may be utilized for transfer of data between various components of an ISP device. The wireless communication capability may be provided by any available wireless connection, e.g., using a Wireless Wide Area Network (WWAN) such as 3^{rd} Generation (3G) WWAN (e.g., in accordance with International Telecommunication Union (ITU) family of standards under the IMT-2000), Worldwide Inter-operability for Microwave Access (“WiMAX, e.g., in accordance with Institute of Electrical and Electronics Engineers (IEEE) 802.16, revisions 2004, 2005, et seq.), Bluetooth® (e.g., in accordance with s IEEE Standard 802.15.1, 2007), Radio Frequency (RF), WiFi (e.g., in accordance with IEEE 802.11a, 802.11b, or 802.11g), etc. Also, the wired communication capability may be provided by any available wired connection, e.g., a shared or private bus (such as a Universal Serial Bus (USB)), one or more (unidirectional or bidirectional) point-to-point or parallel links, etc.

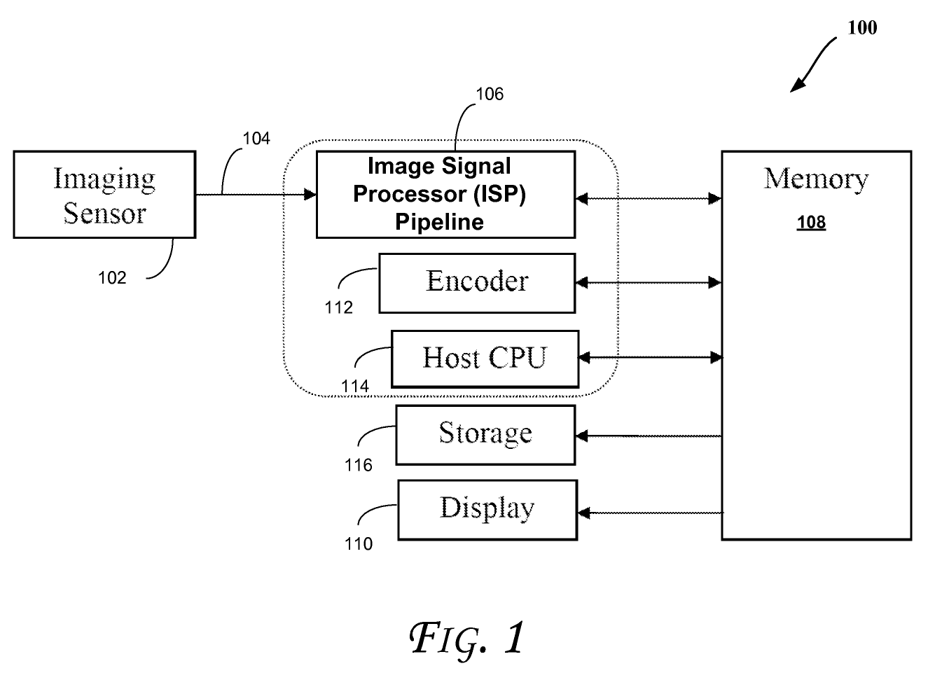

FIG. 1 illustrate a block diagram of a camera imaging system 100, according to an embodiment. In an embodiment, FIG. 1 shows a high level view of a camera imaging system in the context of a mobile device, such as a Smartphone or tablet SoC (System on Chip), although the system 100 may be used for other types of computing devices such as those discussed herein.

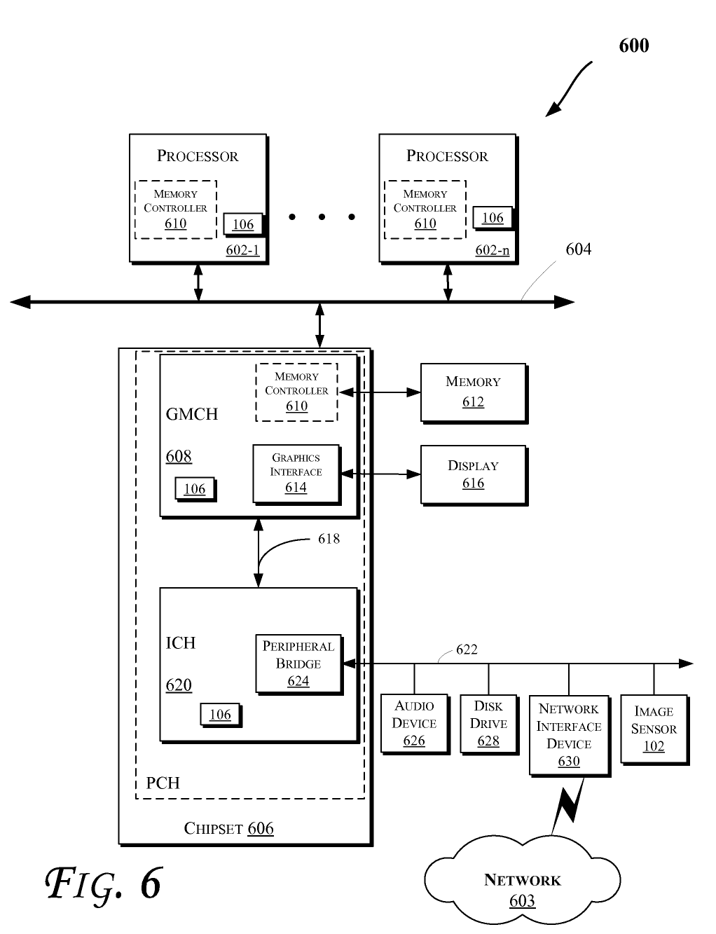

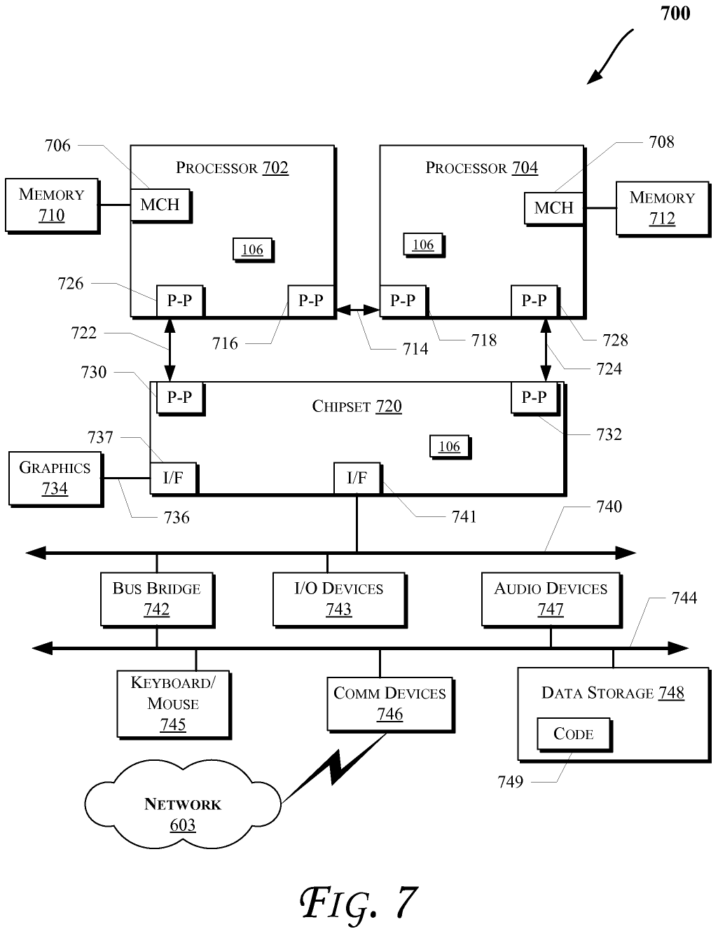

As shown in FIG. 1, an imaging sensor 102 may generate input data 104 to the system 100, e.g., to an ISP pipeline 106 (also referred to herein as an ISP). The data 104 may be provided in Bayer format in an embodiment. Generally, Bayer format refers to a format associated with arrangement of an array of color filters of Red, Green, and Blue (RGB) on a grid of photo sensors used in some digital image sensors. The input data 104 is processed by the ISP pipeline 106 and the results may then be stored in a memory 108 (which may be any type of a memory device such as the memory 612 of FIG. 6 and/or memories 710/712 of FIG. 7), e.g., for either display on a display 110 (which may be the same as or similar to the display 616 of FIG. 6) and/or encoded (e.g., by an encoder 112) for storage in the memory 108. The encoder 112 may encode the processed image data into various formats such as JPEG (Joint Photographic Experts Group) format, GIF (Graphical Interchange File format), TIFF (Tagged Image File Format), etc. Accordingly, the encoder 112 may encode the processed image data into lossy or lossless formats in various embodiments. Hence, the encoder 112 may include a compression/decompression engine/logic in some embodiments.

The system 100 may also include a host CPU 114 (Central Processing Unit, also referred to herein as a processor which may be the same or similar to the processors 602 of FIG. 6 and/or 702/704 of FIG. 7) to execute instructions to perform various operations (see, e.g., the discussion of processors with reference to FIG. 6 or 7). Additionally, the system 100 may include a storage device 116 (which may be a non-volatile storage device that is the same as or similar to the disk drive 628 of FIG. 6 and/or the storage 748 of FIG. 7). The storage device 116 may be used to store data from the memory 108 or load data into the memory 108 for processing by the ISP pipeline 106 and/or host CPU 114 in some embodiments. As shown in FIG. 1, various components (e.g., any of components 106 and 110-116) may have direct (such as read or write) access to the memory 108 in an embodiment.

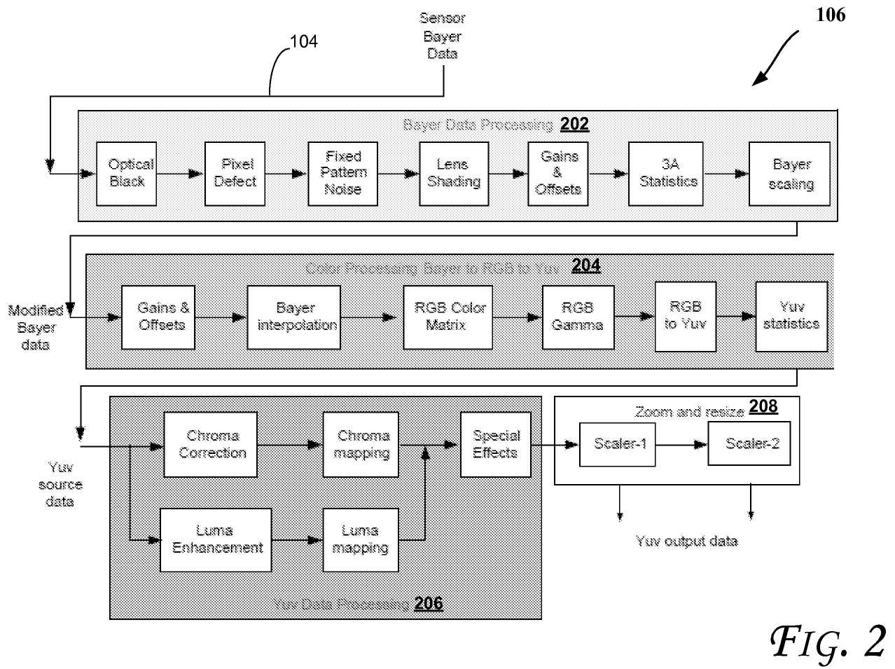

FIG. 2 illustrates a block diagram of data flow and components of an image signal processing pipeline, according to an embodiment. For example, FIG. 2 shows the data flow and components that may be used inside the ISP 106 of FIG. 1. As illustrated, the ISP pipeline 106 is partitioned into several stages/partitions/blocks 202-208. In one embodiment, one or more of the partitions 202-208 may be capable of entering (and be put) into a lower power consumption state (e.g., standby, or otherwise shutdown, when not in use or executing operations, or otherwise to reduce power consumption whether or not in use).

A Bayer data processing block 202 includes logic for correction/processing of original Bayer data 104 such as operations relating to optical black (e.g., compensating black level caused by thermal dark current in the sensor), defective pixels (e.g., correcting pixels that stuck at maximum or minimum), fixed pattern noise (e.g., removing noise in amplifier due to high gain values), lens shading (e.g., correcting uneven intensity distribution caused by lens falloff effect), gains and offsets adjustment, 3A statistics generation and storage (where “3A” refers to Auto exposure, Auto focus, and Auto white balance), and Bayer scaling, such as shown in FIG. 2. Some of these operations may be based on pre-calibrated tables and do not require extensive line buffers. Output of this stage 202 is marked as “Modified Bayer data” and is provided to a color processing block 204 that includes logic to perform gains and offsets adjustment, Bayer interpolation (e.g., interpolating the full RGB color planes from the sub-sampled Bayer plane) to generate full RGB data (via RGB color matrix generation logic and RGB gamma adjustment logic), convert RGB to YUV (Luminance-Chrominance) color space, and generate/store YUV statistics, such as shown in FIG. 2.

In some embodiments, large line buffers are used to implement content adaptive intelligent algorithms in block 204. Output of this stage is marked as “YUV source data” and is provided to a YUV data processing block 206 which includes logic to enhance the YUV data and the following image zoom and resize operation(s) at block 208 (via one or more scaler logics such as illustrated). As shown in FIG. 2, block 206 may include logic to perform chroma correction (e.g., removing artifacts in the chroma channels caused by the previous processing stage), chroma mapping (e.g., applying nonlinear mapping of chroma values based on user preference or display characteristics), luma enhancement (e.g., removing artifacts in the luma channels caused by the previous processing stage), luma mapping (e.g., applying nonlinear mapping of luma values based on user preference or display characteristics), and special effects (such as Emboss, Sepia color, Black & White, etc.). In an embodiment, line buffers are used for blocks 206 and/or 208. Output of this stage is marked as “YUV output data.” There could be multiple outputs to serve different purposes, e.g., display versus storage such as discussed with reference to FIG. 1.

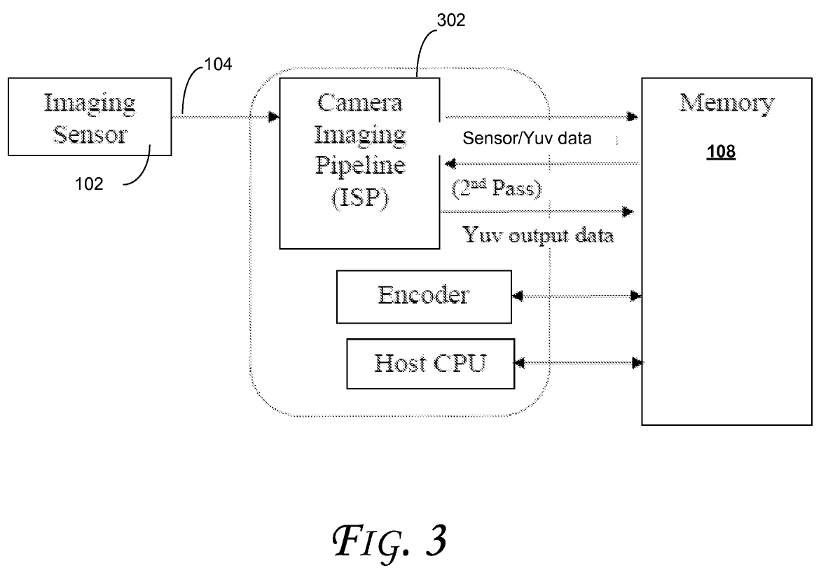

In some implementations such as shown in FIG. 3, a baseline On-The-Fly (OTF) processing data flow model may fully process the Bayer sensor data up to the YUV source data stage, and then write the YUV data to the memory 108 for a second pass processing. Alternatively, the input Bayer data 104 from sensor is directly written out to the memory 108 without any processing. Then, a full camera imaging pipeline 302 is applied to process the stored data in a second pass. Such approaches may be inflexible in the sense that they would be suboptimal under certain conditions or application scenario.

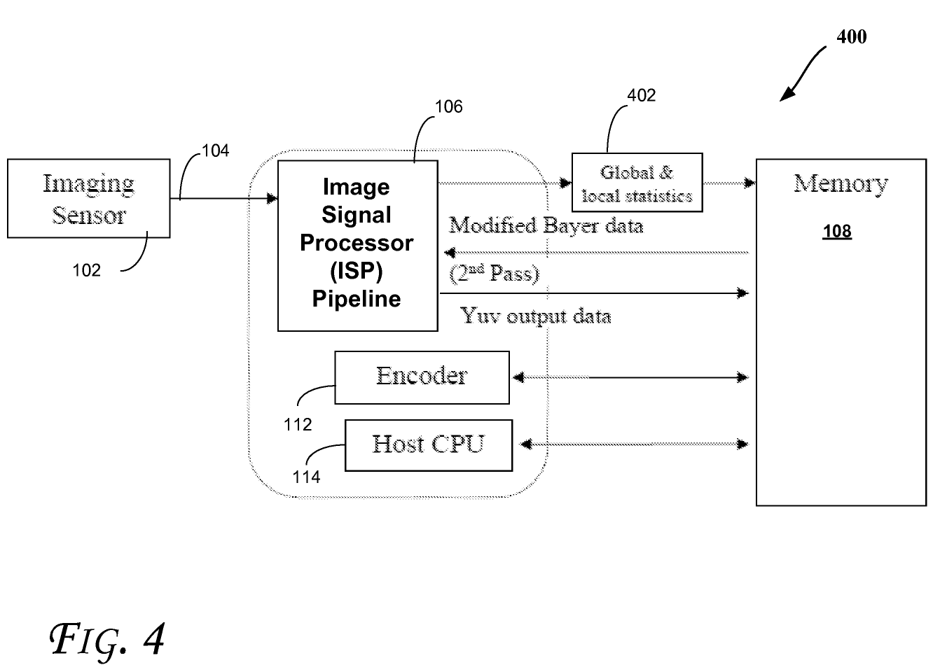

FIG. 4 illustrates a mixed or hybrid online/offline image signal processing model 400, according to an embodiment. In an embodiment, the processing model 400 includes partially processing the sensor data 104 and writing the partially processed data to the memory 108. In a second pass, the modified Bayer data is read back from the memory 108 and the rest of the pipeline processing is applied. Also, a global and local statistics gathering block 402 is used at the end of the modified Bayer data generation. This statistics gathering module is different from a general 3A statistics module. For example, the function of block 402 may be internal to the ISP 106 and it may measure local and/or global statistics that are relevant for the ISP internal functions such as Bayer color interpolation, noise reduction, etc.

Accordingly, a main difference between the three approaches discussed with reference to FIGS. 3 and 4 is in the breakpoint of the imaging pipeline between the first and second pass. Each approach would have certain advantages and disadvantages. For example, the OTF processing may be most suitable for generating frames for continuous video stream, where every image from the sensor source is needed. The imaging pipeline may run at the highest efficiency in this mode. The second approach (first storing the sensor data in memory) would consume the least amount of power in the case that some input frames from the sensor source are actually not needed. Also, since the first pass in this mode is essentially a data pass-through, the response time would be the shortest. In other words, this approach may take in the data as fast as the sensor source is able to produce the data.

Further, the third approach (discussed with reference to FIG. 4) applies minimum processing (e.g., by one or more components of the partition 202 of FIG. 2) to the original sensor data during a first pass (e.g., to the extent that meaningful imaging statistics such as histogram information, edge statistics including both gradient strength and direction, texture statistics, color statistics, shape statistics such as integral image, etc. may be determined but not necessarily that all blocks of the partition 202 of FIG. 2 operate on the original sensor data to modify the original sensor data) and the minimally processed image data is stored in the memory 108 before a second pass. One motivation for collecting these statistics in the first pass is that such information may be used in the second pass to enable content-adaptive processing algorithms such as local histogram based tone mapping etc. that can be performed by the blocks in either partitions 204 or 206 in some embodiments. Since most of the operations performed in the first pass are point based (e.g., where point based generally refers to image calculation performed on a single pixel at a time), the impact on power consumption and response speed are believed to be minimal.

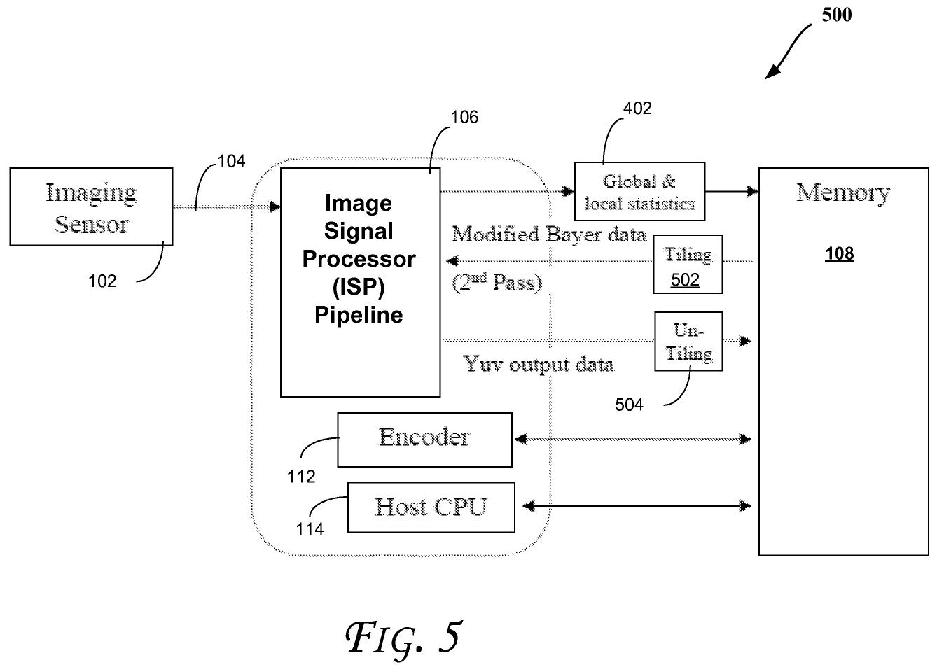

To reduce the impact on power consumption and response speed further, some of the functions may be implemented in fixed hard-wired modules. Another variation of this approach, for example as presented in the following FIG. 5, is to add tiling operations (e.g., via a tilting logic 502 and an untilting logic 504) to the data path for the second pass. Generally, tiling divides an image into overlapping blocks so that the image processing functions may be applied to one block at a time. Tiling may reduce the line buffer requirements, in part, because only a portion of the full line needs to be stored for each image block. It may also reduce the latency in generating the first line of output data. As shown in FIG. 5, the modified Bayer data may be tilted by logic 502 during the second pass and for data being read from the memory 108, while YUV output data may be untilted by logic 504 before storage in the memory 108.

The ISP architecture described above may be employed in various types of computer systems (such as the systems discussed with reference to FIGS. 6 and/or 7). For example, FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors.

Furthermore, the operations discussed with reference to FIGS. 1-5 may be performed by one or more components of the system 600. For example, the ISP 106 discussed with reference to FIGS. 1-5 may be present in one or more components of the system 600 (such as shown in FIG. 6 or other components not shown). Also, the system 600 may include the image sensor 102 or a digital camera such discussed with reference to FIG. 1-5.

A chipset 606 may also communicate with the interconnection network 604. The chipset 606 may include a graphics and memory control hub (GMCH) 608. The GMCH 608 may include a memory controller 610 that communicates with a memory 612. The memory 612 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The GMCH 608 may also include a graphics interface 614 that communicates with a display device 616. In one embodiment of the invention, the graphics interface 614 may communicate with the display device 616 via an accelerated graphics port (AGP) or PCIe. In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the GMCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., Digital Video Interface (DVI)), High Definition Multimedia Interface (HDMI), or other devices.

The bus 622 may communicate with an audio device 626, one or more disk drive(s) 628, and a network interface device 630 (which is in communication with the computer network 603). Other devices may communicate via the bus 622. Also, various components (such as the network adapter 630) may be coupled to the GMCH 608 in some embodiments of the invention. In addition, the processor 602 and the GMCH 608 may be combined to form a single chip. In an embodiment, the memory controller 610 may be provided in one or more of the CPUs 602. Further, in an embodiment, GMCH 608 and ICH 620 may be combined into a Peripheral Control Hub (PCH).

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces.

Furthermore, the operations discussed with reference to FIGS. 1-6 may be performed by one or more components of the system 700. For example, the ISP 106 discussed with reference to FIGS. 1-6 may be present in one or more components of the system 700 (such as shown in FIG. 7 or other components not shown). Also, the system 700 may include the image sensor 102 or a digital camera (not shown) such discussed with reference to FIG. 1-6. The image sensor 102 may be coupled one or more components of system 700 such as a bus (e.g., bus 740 and/or 744) of system 700, the chipset 720, and/or processor(s) 702/704.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may store various data such as those discussed with reference to the memory 612 of FIG. 6.

In an embodiment, the processors 702 and 704 may be one of the processors 602 discussed with reference to FIG. 6. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a graphics circuit 734 via a graphics interface 736, e.g., using a PtP interface circuit 737.

At least one embodiment of the invention may be provided within the processors 702 and 704. Other embodiments of the invention, however, may exist in other circuits, logic units, or devices within the system 700 of FIG. 7. Furthermore, other embodiments of the invention may be distributed throughout several circuits, logic units, or devices illustrated in FIG. 7.

The chipset 720 may communicate with a bus 740 using a PtP interface circuit 741. The bus 740 may communicate with one or more devices, such as a bus bridge 742 and/or I/O devices 743. Via a bus 744, the bus bridge 742 may communicate with other devices such as a keyboard/mouse 745, communication devices 746 (such as modems, network interface devices, or other communication devices that may communicate with the computer network 603), audio I/O device 747, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed herein. Additionally, such computer-readable media may be downloaded as a computer program product, wherein the program may be transferred from a remote computer (e.g., a server) to a requesting computer (e.g., a client) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An image signal processor comprising:
a first partition to process image sensor data in a first color space into modified image sensor data in the first color space;
a second partition to perform color processing of the modified image sensor data and to generate source image data in a second color space; and
a third partition to enhance the source image data to generate output image data,
wherein one or more of the first partition, the second partition, or the third partition are capable of entering into a low power consumption state.

2. The image signal processor of claim 1, further comprising a fourth partition to scale the enhanced source image data.

3. The image signal processor of claim 1, further comprising a tilting logic to divide image data into a plurality of overlapping blocks to allow for image processing operations to be applied to one of the plurality of blocks at a time.

4. The image signal processor of claim 3, wherein the tilting logic is to divide the image data read from a memory.

5. The image signal processor of claim 3, further comprising an untilting logic to combine image data from the plurality of overlapping blocks.

6. The image signal processor of claim 5, wherein the untilting logic is to combine the image data prior to storage in a memory.

7. The image signal processor of claim 5, wherein the tilting logic is to divide the image data read from a memory.

8. The image signal processor of claim 1, wherein, during a first pass, the first partition is to process the image sensor data to determine imaging statistics and wherein, during a second pass after the modified image sensor data is stored in a memory, content-adaptive processing is to be performed based on the imaging statistics.

9. The image signal processor of claim 8, wherein the imaging statistics are to comprise one or more of histogram information and edge statistics.

10. The image signal processor of claim 1, wherein local or global statistics are to be gathered and stored prior to storing the output image data in a memory to allow for content-based processing of the output image data by a next partition of the image signal processor.

11. The image signal processor of claim 1, wherein the image sensor data is generated by an image sensor in Bayer format.

12. The image signal processor of claim 1, wherein the first color space is a Red, Green, and Blue (RGB) color space.

13. The image signal processor of claim 1, wherein the second color space is a Luminance-Bandwidth-Chrominance (YUV) color space.

14. The image signal processor of claim 1, wherein an encoder is to apply encoding to the output image data.

15. A method comprising:
processing image sensor data in a first color space into modified image sensor data in the first color space at a first stage of an image signal processor;
performing color processing of the modified image sensor data and generating source image data in a second color space at a second stage of the image signal processor; and
enhancing the source image data to generate output image data at a third stage of the image signal processor,
wherein one or more of the first stage, the second stage, or the third stage are capable of entering into a low power consumption state.

16. The method of claim 15, further comprising, during a first pass, processing the image sensor data to determine imaging statistics and content-adaptive processing, during a second pass after the modified image sensor data is stored in a memory, based on the imaging statistics.

17. The method of claim 15, further comprising scaling the enhanced source image data.

18. The method of claim 15, further comprising dividing image data into a plurality of overlapping blocks to allow for image processing operations to be applied to one of the plurality of blocks at a time.

19. The method of claim 18, further comprising combining image data from the plurality of overlapping blocks.

20. The method of claim 15, wherein the imaging statistics comprise one or more of histogram information and edge statistics.

21. The method of claim 15, further comprising gathering and storing statistics information prior to storing the output image data in a memory to allow for content-based processing of the output image data by a next stage of the image signal processor.

22. The method of claim 15, further comprising encoding the output image data.

23. A system comprising:
a memory to store output image data corresponding to sensor image data captured by an imaging sensor;
a processor coupled to the memory, the processor comprising:
a first partition to process the image sensor data into modified image sensor data;
a second partition to perform color processing of the modified image sensor data and to generate source image data; and
a third partition to enhance the source image data to generate the output image data,
wherein one or more of the first partition, the second partition, or the third partition are capable of entering into a low power consumption state.

24. The system of claim 23, wherein the processor comprises a fourth partition to scale the enhanced source image data.

25. The system of claim 23, further comprising a tilting logic to divide image data into a plurality of overlapping blocks to allow for image processing operations to be applied to one of the plurality of blocks at a time.

26. The system of claim 25, wherein the tilting logic is to divide the image data read from a memory.

27. The system of claim 25, further comprising an untilting logic to combine image data from the plurality of overlapping blocks.

28. The system of claim 23, wherein, during a first pass, the first partition is to process the image sensor data to determine imaging statistics and wherein, during a second pass after the modified image sensor data is stored in a memory, content-adaptive processing is to be performed based on the imaging statistics.

29. The system of claim 23, wherein local or global statistics are to be gathered and stored prior to storing the output image data in the memory to allow for content-based processing of the output image data by a next partition of the processor.

30. The system of claim 23, wherein an encoder is to apply encoding to the output image data.
